(19) United States
(12) Patent Application Publication
(10) Pub. No.: US 2007/0089711 A1
(43) Pub. Date: Apr. 26, 2007

(54) High-pressure fuel supply system using variable displacement fuel pump

(75) Inventors: Kenichiro Tokuo, Hitachinaka (JP); Hiroyuki Yamada, Hitachinaka (JP); Satoshi Usui, Hitachinaka (JP)

Correspondence Address: CROWELL & MORING LLP;INTELLECTUAL PROPERTY GROUP, P.O. BOX 14300, WASHINGTON, DC, 20044-4300, US

(73) Assignee: Hitachi, Ltd., Chiyoda-ku (JP)

(21) Appl. No.: 11/582,396

(22) Filed: Oct. 18, 2006

(30) Foreign Application Priority Data
Oct. 19, 2005 (JP) 2005-304671

(51) Int. Cl. F02M 57/02; F02M 59/36

(52) U.S. Cl. 123/446; 123/458

(57) ABSTRACT

A high pressure fuel supply system includes: a high pressure fuel pump having a normally closed electromagnetic valve; and a controller for calculating a valve open signal and a valve close signal for the electromagnetic valve in accordance with a state amount of an engine, and supplying a drive current to the electromagnetic valve, wherein the controller applies and the valve close signal having a time duration shorter than a valve close response time during a valve open period of the electromagnetic valve, the valve close response time being a time taken to close the electromagnetic valve after the valve close signal is applied. The controller applies alternately and periodically the valve close signal and valve open signal during the valve open period of the electromagnetic valve.

### BACKGROUND OF THE INVENTION

The present invention relates to a high pressure fuel supply system using a fuel pump of an internal combustion engine, and more particularly to technologies of reducing a calorific power of a variable displacement high pressure fuel pump.

Direct injection engines (spark ignition gasoline direct injection internal combustion engines) of vehicles have been developed recently in order to realize clean exhaust gas and reduce fuel consumption for environment maintenance. In a gasoline direct injection internal combustion engine, fuel is injected via a fuel injection valve directly into a combustion chamber of a cylinder. A grain diameter of fuel injected via the fuel injection valve is reduced to promote burning of injected fuel, reduce particular substances in exhaust gas, reduce fuel consumption, and so on.

In order to reduce a grain size of fuel injected via a fuel injection valve, it is necessary to highly pressurize fuel. Various technologies have been proposed for a high pressure fuel pump for supplying high pressure fuel via a fuel injection valve in a pressurized state (e.g., refer to, for example, JP-A-2000-8997 and JP-A-2005-69668).

According to the technologies described in JP-A-2000-8997, a flow amount of high pressure fuel to be supplied in accordance with a fuel injection amount via the fuel injection valve is controlled to thereby reduce a high pressure fuel pump drive power. As the flow amount control mechanism, electromagnetic valves of two types, a normally opened type and a normally closed type, are described. In both the valves, a volume of fuel to be pressurized by the high pressure fuel pump is controlled by adjusting the timing when the suction valve closes during a discharge process.

The technologies described in JP-A-2005-69668 pertains to a high pressure fuel pump equipped with a normally closed type electromagnetic valve as a suction valve. Collision sounds of a valve body during a valve open operation are reduced by supplying a valve open signal at the timing intermediate of a suction process.

### SUMMARY OF THE INVENTION

In a high fuel pump equipped with a normally closed type electromagnetic valve such as disclosed in JP-A-2002-8997 and JP-A-2005-69668, the electromagnetic valve is continuously supplied with an electric power for a long time in some cases. For example, in the state that fuel is not consumed such as during engine braking, the high pressure fuel pump does not discharge fuel continuously. In this state, since the electromagnetic valve is maintained in a valve open state, the electromagnetic valve is continuously supplied with an electric power. There arise therefore problems such as overheat of the electromagnetic valve, an increase in a consumption energy of a whole system, and a large load on a drive circuit. Although there is a method of controlling a drive current on a drive circuit side to suppress a consumption power of the electromagnetic valve, a current control circuit is generally high in cost, so that this current control method cannot be used in an inexpensive system.

The present invention has been made in consideration of the above-described issues, and it is an object of the present invention to provide a high pressure fuel supply system capable of solving the above-described problems of the related arts.

Another object of the present invention is to provide a high pressure fuel supply system capable of reducing a calorific power of an electromagnetic valve by using an inexpensive structure and reducing a consumption energy and load on a whole system.

In order to solve the above-described issues, the present invention mainly adopts the following configuration.

A high pressure fuel supply system includes: a high pressure fuel pump including a pressurizing chamber for fuel, a pressurizing member for sending fuel in the pressurizing chamber toward a discharge passage in a pressurizing manner, and a normally closed electromagnetic valve disposed in a suction passage, wherein fuel in the pressurizing chamber is compressed by an open/close operation of the electromagnetic valve and a reciprocal operation of the pressurizing member; and a controller for calculating a valve open signal and a valve close signal for the electromagnetic valve in accordance with a state amount of an engine, and supplying a drive current to the electromagnetic valve, wherein the controller applies and the valve close signal having a time duration shorter than a valve close response time during a valve open period of the electromagnetic valve, the valve close response time being a time taken to close the electromagnetic valve after the valve close signal is applied. The controller may apply alternately and periodically the valve close signal and valve open signal during the valve open period of the electromagnetic valve.

In the high pressure fuel supply system, the controller may detect an engine speed of the engine or a drive voltage of the electromagnetic valve and change a ratio between a valve open signal time duration and a valve close signal time duration during the valve open period of the electromagnetic valve in accordance with the detected engine speed or drive voltage.

According to the present invention, the controller of the fuel supply system applies alternately and periodically a valve open signal and a valve close signal during the valve open period of the electromagnetic valve, to thereby realize reduction in an electromagnetic valve drive current and reduction in a calorific power. It is also possible to reduce a consumption power of a whole engine.

Other objects, features and advantages of the invention will become apparent from the following description of the embodiments of the invention taken in conjunction with the accompanying drawings.

### BRIEF DESCRIPTION OF THE DRAWINGS

FIG. 1 is a diagram showing the whole configuration of a high pressure fuel supply system for an internal combustion engine according to an embodiment of the invention;

FIG. 2 is a diagram showing a circuit structure of an electromagnetic valve of a pump and a pump controller in the high pressure fuel supply system of the embodiment;

FIGS. 3A to 3F are timing charts illustrating the operation of the pump and pump controller in the high pressure fuel supply system of the embodiment;

FIG. 4 is a diagram showing a relation between an engine speed and a ratio between a valve open time and a valve close time in the high pressure fuel supply system of the embodiment;

FIG. 5 is a diagram showing a relation between a power supply voltage and a ratio between a valve open time and a valve close time in the high pressure fuel supply system of the embodiment;

FIG. 6 is a diagram showing another circuit structure of an electromagnetic valve of a pump and a pump controller in the high pressure fuel supply system of the embodiment;

FIGS. 7A to 7F are timing charts illustrating the operation of the pump and pump controller shown in FIG. 6 in the high pressure fuel supply system of the embodiment;

FIG. 8 is a diagram showing another circuit structure of an electromagnetic valve of a pump and a pump controller in the high pressure fuel supply system of the embodiment; and

FIGS. 9A to 9G are timing charts illustrating the operation of the pump and pump controller shown in FIG. 8 in the high pressure fuel supply system of the embodiment.

### DESCRIPTION OF THE EMBODIMENT

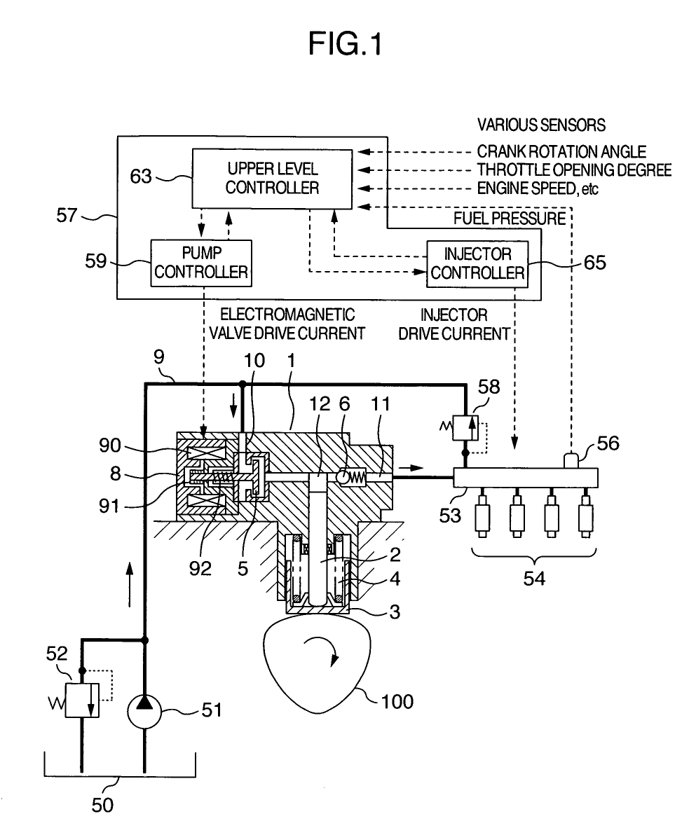

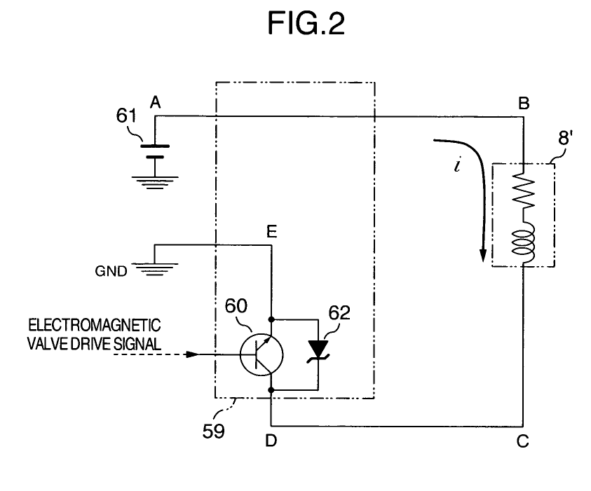

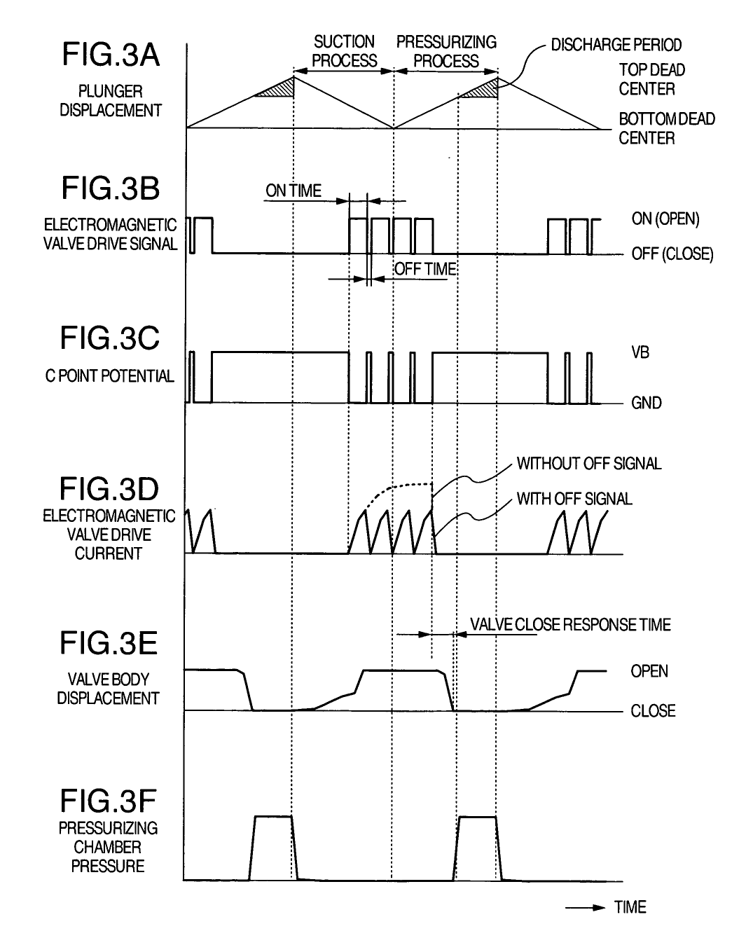

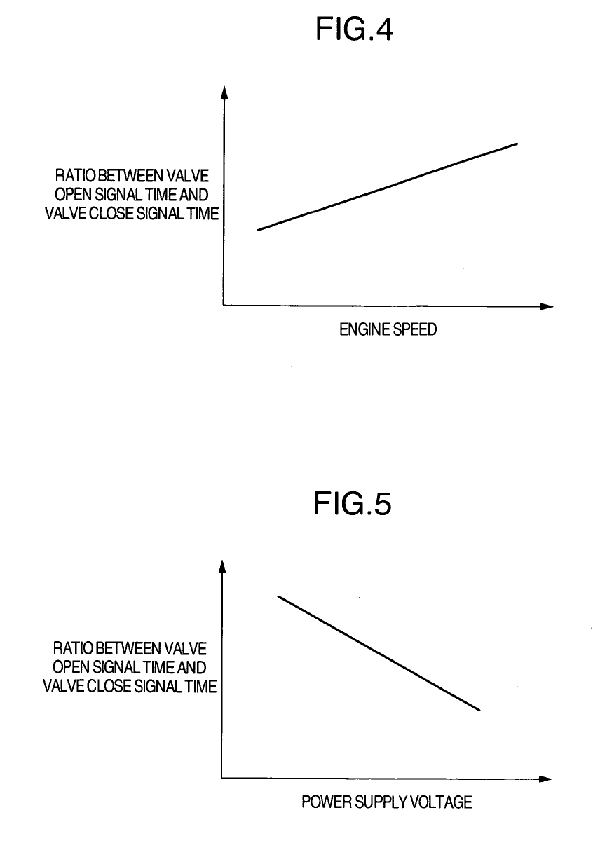

With reference to FIGS. 1 to 9G, detailed description will be made on a high pressure fuel supply system of an internal combustion engine according to the embodiment of the present invention. FIG. 1 is a diagram showing the whole configuration of a high pressure fuel supply system for an internal combustion engine according to the embodiment of the invention. FIG. 2 is a diagram showing a circuit structure of an electromagnetic valve of a pump and a pump controller in the high pressure fuel supply system of the embodiment. FIGS. 3A to 3F are timing charts illustrating the operation of the pump and pump controller in the high pressure fuel supply system of the embodiment. FIG. 4 is a diagram showing a relation between an engine speed and a ratio between a valve open time and a valve close time in the high pressure fuel supply system of the embodiment. FIG. 5 is a diagram showing a relation between a power supply voltage and a ratio between a valve open time and a valve close time in the high pressure fuel supply system of the embodiment.

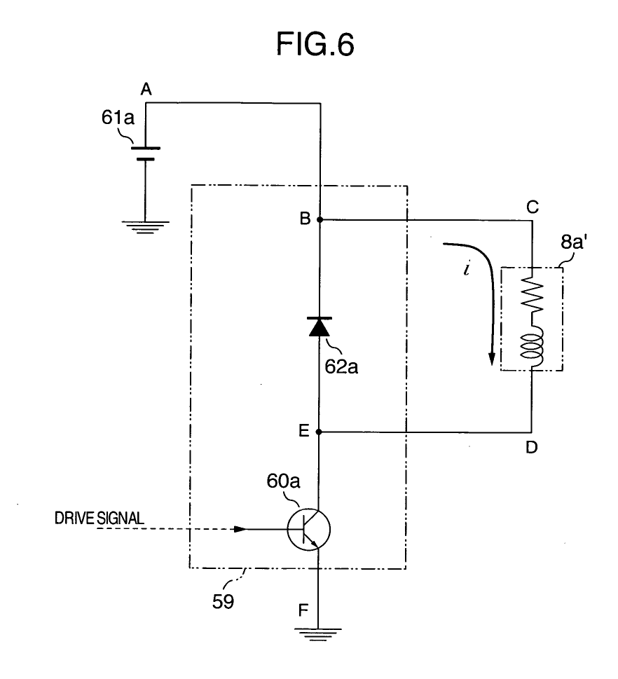

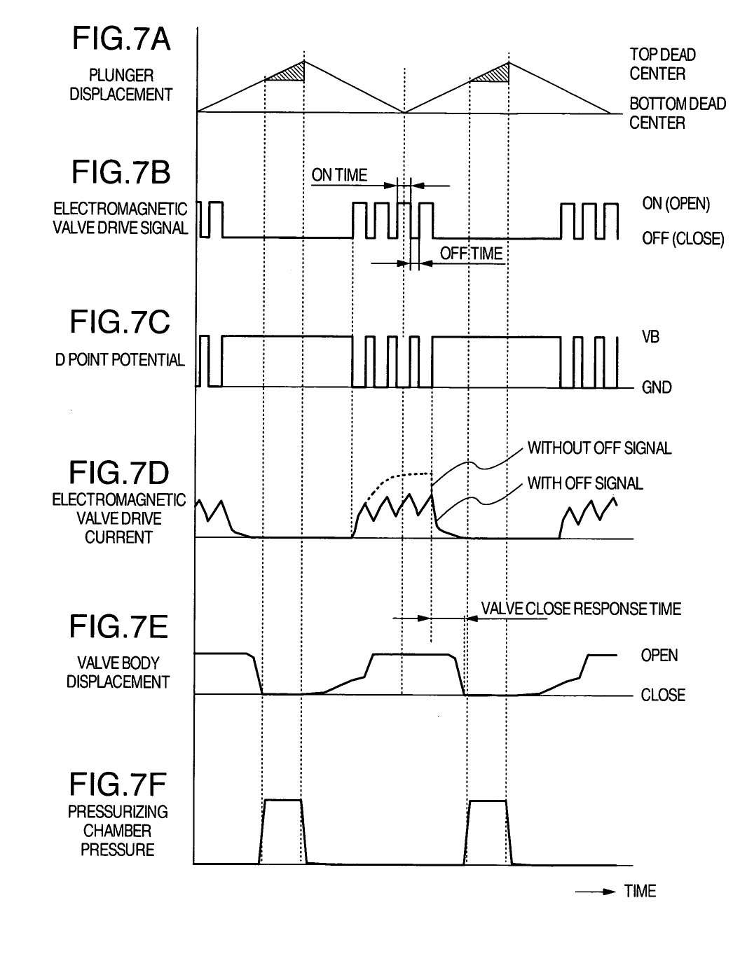

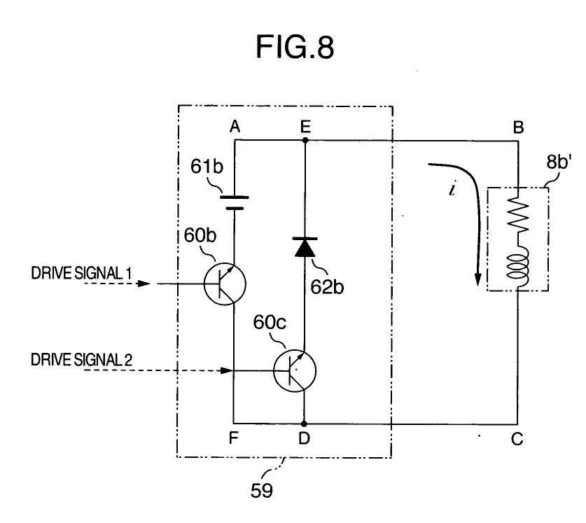

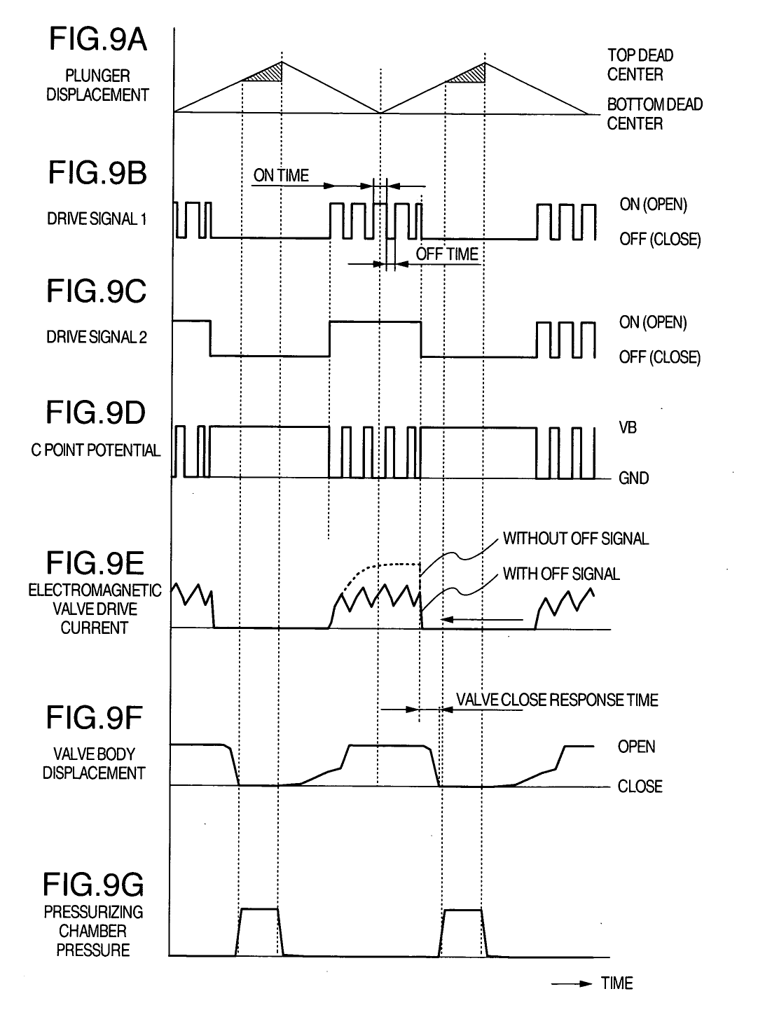

FIG. 6 is a diagram showing another circuit structure of an electromagnetic valve of a pump and a pump controller in the high pressure fuel supply system of the embodiment. FIGS. 7A to 7F are timing charts illustrating the operation of the pump and pump controller shown in FIG. 6 in the high pressure fuel supply system of the embodiment. FIG. 8 is a diagram showing another circuit structure of an electromagnetic valve of a pump and a pump controller in the high pressure fuel supply system of the embodiment. FIGS. 9A to 9G are timing charts illustrating the operation of the pump and pump controller shown in FIG. 8 in the high pressure fuel supply system of the embodiment.

In FIGS. 1 to 9G, reference numeral 1 represents a high pressure fuel pump, 2 represents a plunger, 3 represents a tappet, 5 represents a valve body, 6 represents a discharge valve, 8 represents an electromagnetic valve, 10 represents a suction passage, 11 represents a discharge passage, 12 represents a pressurizing chamber, 51 represents a low pressure pump, 53 represents a common rail, 54 represents injectors, 56 represents a pressure sensor, 59 represents a pump controller, 63 represents an upper level controller, 90 represents a coil, 91 represents an anchor, 92 represents a spring, and 100 represents a cam.

First, with reference to FIG. 1, description will be made on the configuration of a fuel supply system using a variable displacement fuel pump according to the embodiment of the present invention. Formed in the pump main body 1 are the fuel suction passage 10, discharge passage 11 and pressurizing chamber 12. The plunger 2 as a pressurizing member is mounted in the pressurizing chamber 12 in a slidable manner. The discharge valve 6 is disposed in the discharge passage 11 so as not to make high pressure fuel on the downstream side flow reversely toward the pressurizing chamber. The electromagnetic valve 8 is disposed in the suction passage 10 in order to control fuel suction. The electromagnetic valve 8 is a normally closed type electromagnetic valve which closes while power is not supplied and opens while power is supplied.

Fuel is guided from a tank 50 to a fuel guide port of the pump main body 1 by a low pressure pump 51 while a pressure of the fuel is controlled to a constant value by a pressure regulator 52. Thereafter, the fuel is pressurized in the pump main body 1 and fed from a fuel discharge port to the common rail 53 in a pressurized state. The injectors 54, a pressure sensor 56 and a relief valve 58 are mounted on the common rail 53. The relief valve 58 opens when a fuel pressure in the common rail 53 exceeds a predetermined value to prevent breakage of a high pressure piping system. The injectors 54 are mounted as many number as the number of cylinders of the engine, and jet out fuel in accordance with drive currents supplied from an injector controller 65. The pressure sensor 56 sends acquired pressure data to a controller 57.

In accordance with engine state quantities (crank rotation angle, throttle opening degree, engine speed, fuel pressure and the like) supplied from various sensors, the controller 57 calculates a proper jet fuel amount, fuel pressure and the like to control the pump 1 and injectors 54. The controller 57 may have a structure that the upper level controller 63 is provided separately from the controllers 59 and 65 for directly controlling the pump and injectors, or it may be one collective unit. In this embodiment, the pump controller 59 is provided separately from the upper level controller 63 and controls the pump 1.

The plunger 2 is moved reciprocally by the cam 100 which is rotated by an engine cam shaft and the like to thereby change a volume in the pressurizing chamber 12. As the plunger 2 moves down and the volume of the pressurizing chamber 12 expands, the electromagnetic valve 8 opens so that fuel flows into the pressurizing chamber 12 from the fuel suction passage 10. The process while the plunger 2 moves down is hereinafter called a suction process. As the plunger 2 moves up and the electromagnetic valve 8 closes, fuel in the pressurizing chamber 12 is pressurized and supplied to the common rail 53 via the discharge valve 6 in a pressurized state. The process while the plunger 2 moves up is hereinafter called a discharge process.

If the electromagnetic valve 8 closes during the discharge process, fuel sucked in the pressurizing chamber 12 during the suction process is pressurized and discharged to the common rail 53 side. If the electromagnetic valve 8 opens during the discharge process, fuel is pushed back to the suction passage 10 side and the fuel in the pressurizing chamber 12 will not be discharged to the common rail 53 side. In this manner, discharge of fuel in the pump 1 is controlled by open/close of the electromagnetic valve 8. Open/close of the electromagnetic valve 8 is controlled by the pump controller 59.

The electromagnetic valve 8 has as its constituent components the valve body 5, the spring 92 for energizing the valve body 5 toward the valve open direction, the coil 90 and the anchor 91. As current flow through the coil 90, an electromagnetic force is generated in the anchor 91 and the anchor is attracted to the right side as viewed in FIG. 1 so that the valve body 5 integrally formed with the anchor 91 opens. While current does not flow through the coil 90, the spring 92 energizes the valve body 5 toward the valve close direction so that the valve body 5 closes. The electromagnetic valve 8 has a structure that it closes while drive current is not caused to flow, and is called a normally closed electromagnetic valve.

During the suction process, a pressure in the pressurizing chamber 12 is lower than that in the suction passage 10, and this pressure difference opens the valve body 5 so that fuel is sucked in the pressurizing chamber 12. In this case, although the spring 92 energizes the valve body 5 toward the valve close direction, a valve open force by the pressure difference is set larger than the valve close force so that the valve body 5 opens. In this case, as the drive current flows through the coil 90, a magnetic attraction force functions to enhance a motion toward the valve open direction so that the valve body 5 becomes more easy to open.

On the other hand, during the discharge process, a pressure in the pressurizing chamber 12 is higher than that in the suction passage 10 so that a pressure difference for opening the valve body 5 will not be generated. In this case, as the drive current flows through the coil 90, the valve body 5 is closed by a spring force energizing the valve body 1 toward the valve close direction and other forces. On the other hand, if the drive current flows through the coil 90, the valve body 5 is energized toward the valve open direction by a magnetic attraction force.

As the drive current flows through the coil 90 of the electromagnetic valve 8 during the suction process and continues to flow also during the discharge process, the valve body 5 maintains closed. During this period, fuel in the pressurized chamber 12 will not be pressurized because the fuel flows back to the low pressure passage 10. On the other hand, if supply of the drive current is stopped during the discharge process at some timing, the valve body 5 closes and the fuel in the pressurizing chamber 12 is pressurized and discharged toward the discharge passage 11 side. If the timing when the drive current is stopped is fast, a volume of fuel to be pressurized becomes large, whereas if the timing is slow, a volume of fuel to be pressurized becomes small. The controller 57 controls the timing when the valve body 5 closes to thereby control a discharge amount of the pump 1.

FIG. 2 shows an example of a drive circuit of the pump controller 59. Reference numeral 8′ represents the electromagnetic valve 8 shown in FIG. 1 and schematically represented by an electric resistor and an inductance. The drive circuit includes a power source 61, an FET 60 for controlling current on/off and a Zener diode 62 for protecting FET 60 from surge voltage. The Zener diode 62 may be a discrete component as shown in FIG. 2, or it may be assembled in FET 60. The constituent components of the pump controller 59 are shown in an area surrounded by a two-dot chain line.

As a drive signal is applied from the upper level controller 63 or pump controller 59 to FET 60, current flows from the power source 61 to the ground via a circuit of A-B-C-D-E. As the drive signal is not applied, current in the circuit A-B-C-D-E is turned off. Namely, as the drive signal applied to FET 60 is ON, drive current flows through the electromagnetic valve 8′, and as the drive signal is OFF, drive current will not flow through the electromagnetic valve 8′.

Next, with reference to FIGS. 3A to 3F, description will be made on an example of an operation of driving the high pressure fuel pump by a control method, in the high pressure fuel supply system of the embodiment. FIGS. 3A to 3F show an example of timing charts illustrating drive signals and operations of the fuel supply system of the embodiment. A “plunger displacement” shown in FIG. 3A shows the operation of the plunger 2 shown in FIG. 1. A rise indicates a pressurizing process, and a fall indicates the suction process. The example shown in FIGS. 3A to 3F indicates a period during which the plunger 2 moves reciprocally twice. An “electromagnetic valve drive signal” shown in FIG. 3B is a drive signal applied to FET 60 from the pump controller 59 or upper level controller 63.

As described above, in an ON state of the drive signal, drive current flows through the electromagnetic valve 8, and in an OFF state, the drive current flowing through the electromagnetic valve 8 is turned off. In the ON state of the drive signal, an electromagnetic force of the electromagnetic valve 8 energizes the valve body 5 toward the valve open direction so that ON of the drive signal means a valve open signal for the electromagnetic valve 8. In the OFF state of the drive signal, there is no electromagnetic force for energizing the electromagnetic valve 8 toward the valve open direction but an energizing force of the spring 92 opens the valve so that OFF of the drive signal means a valve close signal for the electromagnetic valve 8.

A “C point potential” shown in FIG. 3C indicates a potential at point C in the drive circuit shown in FIG. 2. When the drive signal is OFF, the potential is the same as a power source voltage (VB), and when the drive signal is ON, the potential is the same as a ground potential (GND). An “electromagnetic valve drive current” shown in FIG. 3D indicates a current flowing through the electromagnetic valve 8. As the electromagnetic valve drive signal shown in FIG. 3B turns ON, current flows, and when it turns OFF, the current is turned OFF. Since the electromagnetic valve 8 has an inductance, a rise of current lags from the drive signal. A “valve body displacement” shown in FIG. 3E indicates a displacement of the valve body 5. An “open” position corresponds to the state that the valve body 5 moves to the right and that the suction passage 10 communicates with the pressurizing chamber 12. A “close” position corresponds to the state that the valve body 5 moves to the left and that the suction passage 10 is shut from the pressurizing chamber 12.

During the suction process, a pressure in the pressurizing chamber 12 becomes lower than that in the suction passage 10 so that this pressure difference makes the valve body 5 naturally start moving toward the valve open direction. In this case, if a drive current flows through the electromagnetic valve 8, the magnetic attraction force is generated toward the valve open direction and a valve open operation of the valve body 5 is further accelerated. On the other hand, during the discharge process the valve body 5 maintains its open state only by the magnetic attraction force. If the state that the drive current does not flow continues during some period, the valve body 5 resumes the close position. The time taken for the valve body 5 to close after the drive signal is turned OFF is hereinafter called a “valve close response time” (there is a response delay of the valve close response time until the valve body 5 actually closes from an off time point of the electromagnetic valve drive signal.

As the valve body 5 closes, a pressure in the pressurizing chamber 12 rises and fuel is discharged. FIG. 3F shows a pressure in the pressurizing chamber. The pressure starts rising during the pressurizing process at the timing when the valve body 5 closes, and fuel continues to be discharged until the pressurizing process terminates. A period while fuel is discharged is indicated as a hatched portion shown in FIG. 3A. The longer this period, a fuel discharge amount becomes larger.

In a state that it is necessary for the pump 1 to discharge more fuel, as in the case that an output of the internal combustion engine is high, the electromagnetic valve drive signal is turned OFF fast to close the valve body 5 from the start of the pressurizing process in order to prolong the discharge period. In a state that it is necessary for the pump 1 to discharge less fuel, as in the case that an output of the internal combustion engine is low, the electromagnetic valve drive signal is turned OFF slowly to close the valve body 5 from the last half of the pressurizing process in order to shorten the discharge period. Since there is a predetermined lag time until the valve body 5 closes, the timing when the electromagnetic valve drive signal is turned OFF is determined by the timing when the valve body 5 is desired to be closed, advanced by the valve open delay time.

As shown in FIG. 3B, the electromagnetic valve drive signal is turned ON/OFF a plurality of times during one valve open period (valve open period of the valve body 5 as shown in FIG. 3E). If an OFF signal is applied while the valve body 5 opens, the valve body 5 tends to close. However, if the OFF period is shorter than the valve close response time, the next ON signal is supplied before the valve body opens so that the open state of the valve body 5 is maintained. On the other hand, if the OFF signal continues to be applied for a period longer than the valve close response time, the valve body 5 closes and the pump 1 starts discharging fuel. In this manner, by applying the OFF signal (valve close signal) shorter than the valve close signal during the valve open period, it becomes possible to reduce an amount of current flowing through the electromagnetic valve 8 and reduce a calorific power.

FIG. 3D shows a current waveform indicated by a solid line when the OFF signal exists during the valve open period, and a current waveform indicated by a dotted line when the OFF signal does not exist. If the OFF signal does not exist during the valve open period (continuously ON), the drive current reaches a saturated current, whereas if the OFF signal exists during the valve open period, a current value is lowered more than when the current flows continuously. Further, since the current value lowered each time the OFF signal is applied, a cumulative value of calorific powers can be reduced. The control method described above can be realized because the OFF signal has such a period as the valve body 5 will not close.

FIG. 3E shows an example in which a displacement of the valve body 5 during the valve open period maintains the valve open state. The embodiment is not limited thereto. A valve body motion may take a case in which the valve body 5 moves toward the valve close direction to some extent and then resumes the open state. Namely, a pressure in the pressurizing chamber 12 will not rise because even if the valve body 5 moves toward the valve close direction to some extent, fuel in the pressurizing chamber 12 escapes into the fuel suction passage 10 via a space near the valve body. In other words, it is sufficient if the valve body 5 opens to the extent that fuel in the pressurizing chamber 12 can escape into the fuel suction passage 10 (it is sufficient even if a perfect open state is not obtained).

This embodiment adopts the arrangement that the electromagnetic valve opens with an electromagnetic valve drive signal ON and it closes with a signal OFF. If the command of the electromagnetic valve drive signal is reversed (ON=valve close, OFF =value open), it is sufficient if an ON signal having such a time duration as the valve will not close during the valve open period. In both the arrangements, the embodiment can be realized by applying a valve close signal having such a time duration as the electromagnetic valve 8 will not close during the valve open period of the electromagnetic valve 8.

In addition to the control method of the embodiment by which a valve open signal having a time duration shorter than the valve close response time is applied during the electromagnetic valve open period, an approach may be adopted by which a time ratio between the valve open signal and valve close signal during the valve open period is changed with an operation state of the internal combustion engine, to further reduce the calorific power. Namely, as shown in FIG. 4, the time ratio between the valve open signal and valve close signal during the valve open period is changed with an increase in an engine speed.

The reason of this arrangement is that the valve close response time of the electromagnetic valve changes with the operation state of the engine. This is because the engine speed is proportional to an operation speed of the plunger 2 and an operation speed of the electromagnetic valve 8 is influenced by fuel stirred by the plunger 2. There is therefore a general tendency that the lower the engine speed, the longer the valve close response time is, and the higher the engine speed, the shorter the valve close response time is.

By utilizing the above-described general tendency, the calorific power of the electromagnetic valve 8 can be reduced further by applying a long valve close signal when the engine speed is low. For example, as a specific method of realizing this, logic for realizing map control of the ratio between ON and OFF is assembled in the upper level controller 63 or pump controller 59 for calculating the electromagnetic valve drive signal. This control is performed by detecting a low engine speed and prolonging the valve close signal (shortening the drive signal ON time for the electromagnetic signal) to reduce further the electromagnetic valve calorific power.

As another method of further reducing the electromagnetic valve calorific power, as shown in FIG. 5, the time ratio between the valve open signal and valve close signal during the valve open period is changed with a rise of a power supply voltage. If a voltage for driving the electromagnetic valve is high, a rise of the drive current is faster than when the drive voltage is low. Therefore, the valve open state can be maintained by a shorter ON time than when the drive voltage is low. By utilizing this tendency, the calorific power of the electromagnetic valve 8 and a electric consumption power of the system can be reduced by detecting a high power supply voltage and shortening the ON time.

In the control method described above by which the time ratio between the valve open signal and valve close signal during the valve open period is changed with the operation state of the internal combustion engine to further reduce the calorific power, the engine speed and power supply voltage are used as the example of the operation state. The operation state is not limited thereto, but it may be a flow rate of fuel discharged from the fuel pump, an operation speed of the pressurizing member (plunger 2), and a discharge flow amount of the fuel pump. These examples of the operation state are parameters related to the engine speed and engine load (e.g., discharge flow amount). Of these parameters, the plunger operation speed can be detected as an engine speed, and the discharge flow amount can be detected as an injector injection amount. In accordance with a detected value, control is performed to change the time ratio between the valve open signal and valve close signal.

Next, with reference to FIG. 6 and FIGS. 7A to 7F, description will be made on another drive/control operation of the high pressure pump of the embodiment. FIG. 6 shows an example of another circuit structure different from that shown in FIG. 2. Reference numeral 8a′ represents the electromagnetic valve 8 shown in FIG. 1 and schematically represented by an electric resistor and an inductance. The drive circuit includes a power source 61a, an FET 60a for controlling current on/off and a free wheel diode 62a. The free wheel diode 62a constitutes a circuit B-C-D-E for circulating current generated by a counter-electromotive force of the electromagnetic valve 8a′. The constituent components of the pump controller 59 are shown in an area surrounded by a two-dot chain line.

As a drive signal is applied from the upper level controller 63 or pump controller 59 to FET 60a, current flows from the power source 61a to the ground via a circuit of A-B-C-D-E-F. As the drive signal changes from the ON state to the OFF state, current generated by the counter-electromotive force circulates and attenuated in the circuit B-C-D-E. Similar to the above-described embodiment, as the drive signal is applied to FET 60a, a drive current flows through the electromagnetic valve 8a′.

FIGS. 7A to 7F show an example of timing charts illustrating drive signals and valve operations of the circuit structure shown in FIG. 6. Similar to FIGS. 3A to 3F, a “plunger displacement” shown in FIG. 7A shows the reciprocal operation of the plunger 2 shown in FIG. 1. An “electromagnetic valve drive signal” shown in FIG. 7B is a drive signal applied to FET 60a from the pump controller 59 or upper level controller 63. In an ON state of the drive signal, drive current flows through the electromagnetic valve 8, and in an OFF state, the drive current flowing through the electromagnetic valve 8 attenuates. Similar to the structure shown in FIGS. 1 to 3F, ON of the drive signal is a valve open signal for the electromagnetic valve 8, and OFF of the drive signal is a valve close signal for the electromagnetic valve 8.

A “D point potential” shown in FIG. 7C indicates a potential at point D in the drive circuit shown in FIG. 6. When the drive signal is OFF, the potential is the same as a power source voltage (VB), and when the drive signal is ON, the potential is the same as a ground potential (GND). An “electromagnetic valve drive current” shown in FIG. 7D indicates a current flowing through the electromagnetic valve 8. As the electromagnetic valve drive signal shown in FIG. 7B turns ON, current flows, and when it turns OFF, the current attenuates. A “valve body displacement” shown in FIG. 7E indicates a displacement of the valve body 5. A flow amount control method of controlling a discharge flow amount by controlling the timing when the valve body 5 is closed is the same as the method illustrated in FIGS. 1 to 3F.

A different point from the circuit structure shown in FIG. 2 resides in that it takes a time to attenuate the electromagnetic valve drive current and that it takes a long time (valve close response time) to be taken to close the valve body 5 from when the electromagnetic valve drive signal is turned OFF. Also in this case, the electromagnetic valve drive signals ON and OFF are periodically applied during the open period of the valve body 5 from the suction process to the discharge process. Therefore, the drive current repeats alternately an increase and an attenuation as indicated by a solid line in FIG. 7D to form a waveform like pseudo current control (the drive current shown in FIG. 7D is formed in a pseudo manner by periodically applying the electromagnetic drive signals ON and OFF during the open period of the valve body 5 without performing direct current control to form the drive current shown in FIG. 7D). As compared with no OFF signal indicated by a dotted line, an average current reduces more so that the calorific power of the electromagnetic valve 8 and the whole system consumption power can be reduced. This circuit structure has advantages of good durability of the electric circuit because a surge voltage is not loaded on FET 60 and Zener diode 62 as in the circuit shown in FIG. 2.

Next, with reference to FIG. 8 and FIGS. 9A to 9G, description will be made on another drive/control operation of the high pressure pump of the embodiment. FIG. 8 shows an example of another circuit structure different from that shown in FIG. 2. This circuit structure drives the electromagnetic valve by using two FETs.

In order to make current rise, an ON signal is applied to FETs 60b and 60c. Current starts flowing from a power source 61b and through a circuit A-E-B-C-D-F. Next, when the drive signal for FET 60b is turned OFF while the ON signal is applied to FET 60c, the current circulates and attenuates in a circuit B-C-D-E. When both the drive signals 1 and 2 are turned OFF, the circulated current extinguishes at once.

FIGS. 9A to 9G show an example of timing charts illustrating drive signals and valve operations of the drive circuit shown in FIG. 8. As different from the drive circuits shown in FIGS. 2 and 6, the electromagnetic valve drive signal include two systems: “drive signal 1” as a command value for FET 60b and a “drive signal 2” as a command value for FET 60c. These drive signals are applied to FET 60b and FET 60c in accordance with calculations by the pump controller 59 or upper level controller 63. A “C point potential” shown in FIG. 9D indicates a potential at point C in the drive circuit shown in FIG. 8. When the drive signal 1 is OFF, the potential is the same as a power source voltage (VB), and when the drive signal 1 is ON, the potential is the same as a ground potential (GND).

An “electromagnetic valve drive current” shown in FIG. 9E indicates a current flowing through the electromagnetic valve 8. As the drive signal 1 is turned ON while the drive signal 2 is turned ON, current increases, and as the drive signal 1 is turned OFF while the drive signal 2 is turned ON, current attenuates. Similar to the free wheel circuit shown in FIG. 6, the electromagnetic valve drive current repetitively increases and decreases while the drive signal 2 is tuned ON. When the drive signals 1 and 2 are turned OFF, the current waveform is extinguished at once similar to the circuit shown in FIG. 2.

In this circuit structure, the drive signals 1 ON and OFF are periodically applied during the open period of the valve body 5 from the suction process to the discharge process. Therefore, similar to the circuit structure shown in FIGS. 7A to 7F, the drive current repeats alternately an increase and an attenuation as indicated by a solid line in FIG. 9E to perform pseudo current control. As compared with no OFF signal indicated by a dotted line, an average current reduces more so that the calorific power of the electromagnetic valve 8 and the whole system consumption power can be reduced. Further, a surge voltage is not loaded on FET 60b and FET 60c so that this circuit structure has advantages of good durability. Moreover, similar to the circuit shown in FIG. 2, extinguishment of the last current can be made sharp so that it is possible to obtain a short valve close response time like that of the circuit shown in FIG. 2.

The condition of performing control of the high pressure fuel supply system of the embodiment may be parameters such as an engine speed and an engine load. It becomes more effective if the embodiment control method (a control method of applying a valve open signal having a time duration shorter than the valve close signal response time of the electromagnetic valve during the electromagnetic valve open period) is executed at a particular engine speed or engine load. For example, if an engine speed is low, the time duration of the valve close signal can be prolonged because the valve close response time is long, and the calorific power can be reduced further effectively. Conversely, if the engine speed is high, it becomes necessary to shorten the time interval of valve close signals so that reduction in the calorific power cannot be expected too much even if the embodiment control method is adopted. It is therefore effective to adopt the embodiment control method only at a particular engine speed. A simple control method may be adopted by which an engine speed or engine load is detected, and if the detected value exceeds a threshold value, a time duration of the valve close signal during the valve open period is set to zero (another control method providing the effects of calorific power reduction may be performed depending upon a value of the engine speed or engine load, or if such effects cannot be expected, the valve close signal may be set to zero).

Although there is a conventional drive current reduction method using current control, a current control circuit having a feedback function through detection of a current value is generally expensive. The embodiment of the present invention can be realized by using a circuit which does not have a current detector circuit and a feedback circuit, such as the circuit structures shown in FIGS. 2, 6 and 8. A system cost can therefore be reduced.

As described so far, the high pressure fuel supply system according to the embodiment of the present invention has the following configuration to realize the functions and operations thereof. Namely, the pressure fuel supply system includes: a high pressure fuel pump including a pressurizing chamber for fuel, a pressurizing member for sending fuel in the pressurizing chamber toward a discharge passage in a pressurizing manner, and a normally closed electromagnetic valve disposed in a suction passage, wherein fuel in the pressurizing chamber is compressed by an open/close operation of the electromagnetic valve and a reciprocal operation of the pressurizing member; and a controller for calculating a valve open signal and a valve close signal for the electromagnetic valve in accordance with a state amount of an engine, and supplying a drive current to the electromagnetic valve, wherein the controller applies and the valve close signal having a time duration shorter than a valve close response time during a valve open period of the electromagnetic valve, the valve close response time being a time taken to close the electromagnetic valve after the valve close signal is applied. A calorific power of the electromagnetic valve can therefore be reduced by avoiding continuous power supply to the electromagnetic valve, while the open state of the electromagnetic valve is maintained.

Since the valve open signal is turned off before the drive current reaches a saturated current, a peak value of the drive current can be reduced. It is therefore possible to realize reduction in a calorific power of the electromagnetic valve, reduction in a consumption power of a whole system and reduction in a load on the drive circuit. Since the control method of the invention does not require a current feedback function, drive means can be realized with low cost. The controller applies alternately and periodically the valve open signal and valve close signal during the open state of the electromagnetic valve to thereby maintain an open state of the electromagnetic valve. It is therefore possible to efficiently provide a longer power supply stop period to thereby realize further reduction in the calorific power.

The ratio between the valve open time duration and valve close time duration is changed with a flow rate of fuel flowing in the pump. A response time of the electromagnetic valve is influenced by the flow rate of fuel flowing in the pump. Namely, if a flow rate is fast, a large fluid force is applied to the electromagnetic valve so that a valve close operation is fast. On the other hand, if the flow rate is slow, the valve close operation is slow. Therefore, if the flow rate is slow, the valve open state can be maintained even if the valve close signal is applied for a long time. If the flow rate is slow, i.e., if the flow rate of discharged fuel is slow, a ratio of the valve open signal is lowered so that the calorific power can be reduced further.

The controller has means for detecting an operation speed of the pressurizing member, a drive voltage of the electromagnetic valve, and a discharge flow amount and means for changing the ratio between the valve open signal and valve close signal in accordance with the operation signal, drive voltage and discharge flow amount. A longest power supply stop period can be provided in accordance with the operation speed, drive voltage and discharge flow amount, so that the calorific power can be reduced further.

The slower the operation speed of the pressurizing member is, the smaller the ratio of the valve open signal to the valve close signal is set. Since the fluid force applied to the electromagnetic valve is weak if the operation speed of the pressurizing member is slow, the valve open state can be maintained even if the ratio of the valve open signal time duration is made small. By applying a shortest valve open signal in accordance with the operation state of an internal combustion engine, the calorific power can be reduced further. The higher the drive voltage of the electromagnetic valve is, the smaller the ratio of the valve open signal time duration to the valve close signal time duration is set. Since a large current flows through the electromagnetic valve if the drive voltage is high, a sufficient valve holding power can be obtained even with a shorter power supply time. If the drive voltage is high, a power supply time is shortened so that the calorific power during high voltage drive can be reduced. As described above, the controller of the high pressure fuel supply system of the embodiment can realize reduction in the calorific power of the electromagnetic valve and reduction in a consumption power of the whole system, by applying the valve close signal during the valve open operation.

It should be further understood by those skilled in the art that although the foregoing description has been made on embodiments of the invention, the invention is not limited thereto and various changes and modifications may be made without departing from the spirit of the invention and the scope of the appended claims.

1. A high pressure fuel supply system comprising:
a high pressure fuel pump including a pressurizing chamber communicating with a suction passage and a discharge passage of fuel, a pressurizing member for sending fuel in said pressurizing chamber toward said discharge passage in a pressurizing manner, a discharge valve disposed in said discharge passage and a normally closed electromagnetic valve disposed in said suction passage, wherein fuel in said pressurizing chamber is compressed by an open/close operation of said electromagnetic valve and a reciprocal operation of said pressurizing member; and
a controller for calculating a valve open signal and a valve close signal for said electromagnetic valve in accordance with a state amount of an engine and supplying a drive current to said electromagnetic valve, wherein said controller applies said valve close signal having a time duration shorter than a valve close response time during a valve open period of said electromagnetic valve, said valve close response time being a time taken to close said electromagnetic valve after said valve close signal is applied.

2. The high pressure fuel supply system according to claim 1, wherein a time duration of said applied valve close signal is a time duration not completely closing said electromagnetic valve.

3. The high pressure fuel supply system according to claim 1, wherein said controller applies alternately and periodically said valve close signal and said valve open signal during the valve open period of said electromagnetic valve.

4. The high pressure fuel supply system according to claim 1 wherein said controller detects an engine speed of said engine and changes a ratio between a valve open signal time duration and a valve close signal time duration during the valve open period of said electromagnetic valve in accordance with said detected engine speed.

5. The high pressure fuel supply system according to claim 4, wherein a ratio of said valve open time duration to said valve close time duration becomes smaller as said engine speed lowers.

6. The high pressure fuel supply system according to claim 1, wherein said controller detects a drive voltage of said electromagnetic valve, an operation speed of said pressurizing member or a discharge flow amount of said high pressure fuel pump, and changes a ratio between a valve open signal time duration and a valve close signal time duration during the valve open period of said electromagnetic valve in accordance with said detected drive voltage, operation speed or discharge flow amount.

7. The high pressure fuel supply system according to claim 6, wherein a ratio of said valve open time duration to said valve close time duration becomes smaller as a power supply voltage of said electromagnetic valve becomes high.

8. The high pressure fuel supply system according to claim 3, wherein said controller detects an engine speed or an engine load, and if a detected value exceeds a threshold value, a time duration of said valve close signal during said valve open period is set to zero.
